(19) United States
(12) Patent Application Publication
(10) Pub. No.: US 2016/0187819 A1
(43) Pub. Date: Jun. 30, 2016

(54) IMAGE FORMING APPARATUS

(71) Applicant: CANON KABUSHIKI KAISHA, Tokyo (JP)

(72) Inventors: Tsuyoshi Tajiri, Tokyo (JP); Rin Ishikawa, Ushiku-shi (JP)

(21) Appl. No.: 15/065,063

(22) Filed: Mar. 9, 2016

Related U.S. Application Data
(63) Continuation of application No. PCT/JP2014/074761, filed on Sep. 12, 2014.

(30) Foreign Application Priority Data
Sep. 13, 2013 (JP) 2013-190280

(51) Int. Cl. G03G 15/01

(52) U.S. Cl. CPC G03G 15/1615

(57) ABSTRACT

To provide an image forming apparatus capable of easily suppressing a variation of an inclination of a sensor relative to an endless belt and the capable of high accuracy and stabilized sensing operation.

An image forming apparatus (100) includes a belt unit (200) having an endless belt supported to be rotatable in a circumferential direction (R), an image forming unit (1Y, 1M, 1C, 1Bk) for forming an image on the belt unit, and an optical sensor (31) for detecting light projected onto the endless belt. The image forming apparatus further comprises a sensor supporting member (32) for supporting the sensor, and a positioning portion (400, 500) including, as a unit, a first positioning portion (400a, 500a) for positioning the belt unit by being contacted by the belt unit and a second positioning portion (401a, 501a, 501b) positioning the sensor supporting member by being contacted by the sensor supporting member.

### TECHNICAL FIELD

The present invention relates to an image forming apparatus such as a copying machine, a facsimile machine, a printing machine, and the like, which is structured so that a sensor can be accurately positioned relative to a belt unit such as the intermediary transfer belt unit of the apparatus.

### BACKGROUND ART

In the field of an image forming apparatus which uses an electrophotographic image forming method, image forming apparatuses of the so-called intermediary transfer type, which form a full-color toner image on the intermediary transfer belt (ITB), are known. Among high speed image forming apparatuses of this type, some are enabled to keep their endless belt within a preset range in terms of the lengthwise direction of one of the rollers by which the belt is suspended and kept tensioned (direction parallel to one of rollers), by detecting the amount of the positional deviation of the endless belt such as the intermediary transfer belt, conveyance belt, and the like, and controlling the roller in alignment.

One of the primary problems which image forming apparatuses such as those described above suffer is color deviation attributable to the positional deviation of their endless belt in terms of the primary scanning direction, and the secondary scanning direction (parallel to belt conveyance direction), of the laser scanner, stretching or shrinking of toner image in terms of the primary scan direction, angular deviation of toner image relative to the primary scan direction, etc. Another problem is that the apparatuses change in toner density due to inaccuracy in the components related to development, transfer, etc., changes in ambient temperature and humidity, cumulative usage of apparatus, and the like factors, and therefore, the apparatuses become nonuniform in terms of image density.

Thus, some image forming apparatuses of the above-described type are structured to form a pattern to be used for compensating for color deviation density deviation, as means for measuring the amount of color deviation, on the intermediary transfer belt with preset intervals, detect the pattern with the use of a sensor, and correct the apparatuses in image formation position and image density. In the case of these apparatuses, in order to accurately detect the amount of color deviation and image density, the inaccuracy in the positional relationship between the endless belt and sensor has to be minimized.

In the past, there has been disclosed in Japanese Patent No. 3473346, for example, an apparatus structured so that a sensor of the reflection type is attached to the frame of the belt unit, and the frame is positioned relative to the shaft of the idler roller which is one of the rollers by which the intermediary transfer belt is suspended and kept tensioned, with the placement of the positioning plate between the frame and the shaft (rotational axle) of the idler roller. According to this art, the belt unit is equipped with an endless belt such as an intermediary transfer belt 10, for example, and a preset detection mark (test patch) is formed on the endless belt by an image forming section. Then, the information which can be obtained by detecting the test patch with the use of an optical sensor is used.

According to the conventional arts which include the one described in Japanese Patent No. 3473346, the distance between the endless belt and the sensor of the reflection type can be kept stable with the use of the positioning plate. However, with the use of only the conventional arts, it is difficult to keep the sensor stable in its angle relative to the surface of the intermediary transfer belt, for the following reason. That is, the angle of the belt unit in terms of the direction indicated by a referential mark θ (angle of belt unit at plane perpendicular to shaft (rotational axle) of belt-suspending-tensioning roller) is determined by the main assembly of an image forming apparatus, whereas the angle of the belt surface is determined by the belt-suspending-tensioning roller of the belt unit. On the other hand, the angle of the optical sensor relative to the belt surface in terms of the direction indicated by the arrow mark θ is determined by the positioning plate attached to the main assembly of the image forming apparatus.

That is, the angle of the sensor of the reflection type relative to the belt surface is determined by a combination of the angle of the belt surface relative to the belt unit, and the angle between the positioning plate and sensor unit, including their deviation. Therefore, with the use of any of the conventional arts, it has been difficult to ensure that the angular deviation of the optical sensor relative to the belt surface in terms of the direction indicated by the referential mark θ remains minimum.

### SUMMARY OF THE INVENTION

The present invention is characterized in that an image forming apparatus comprises a belt unit having an endless belt supported to be rotatable in a circumferential direction, an image forming unit for forming an image on the belt unit, and an optical sensor for detecting light projected onto the endless belt. The image forming apparatus further comprises a sensor supporting member for supporting the sensor, and a positioning portion including, as a unit, a first positioning portion for positioning the belt unit by being contacted by the belt unit and a second positioning portion positioning the sensor supporting member by being contacted by the sensor supporting member.

### BRIEF DESCRIPTION OF THE DRAWINGS

FIG. 1 is a schematic sectional view of the image forming apparatus in one of the preferred embodiments of the present invention; it shows the overall structure of the apparatus.

FIG. 2 is a perspective view of the entirety of the positioning device of the image forming apparatus shown in FIG. 1.

FIG. 3 is a side view of the positioning device, shown in FIG. 2, as seen from the direction indicated by an arrow A in FIG. 2.

Part (a) of FIG. 4 is a front view of the positioning device shown in FIG. 2, and part (b) of FIG. 4 is a rear view of the positioning device shown in FIG. 2.

FIG. 5 is a partially exploded perspective view of the positioning device shown in FIG. 2.

Parts (a) and (b) of FIG. 6 are drawings for describing the definition of the sensor attitude.

Part (a) of FIG. 7 is a schematic drawing of the sensor after the angular displacement of the sensor in the direction indicated by the arrow mark θ; part (b) of FIG. 7 is a schematic drawing of the sensor after the linear deviation of the sensor in the direction indicated by the arrow mark Z; and part (c) of FIG. 7 is a schematic drawing of the sensor after the angular deviation of the sensor in the direction indicated by the arrow mark cp.

### DESCRIPTION OF THE EMBODIMENTS

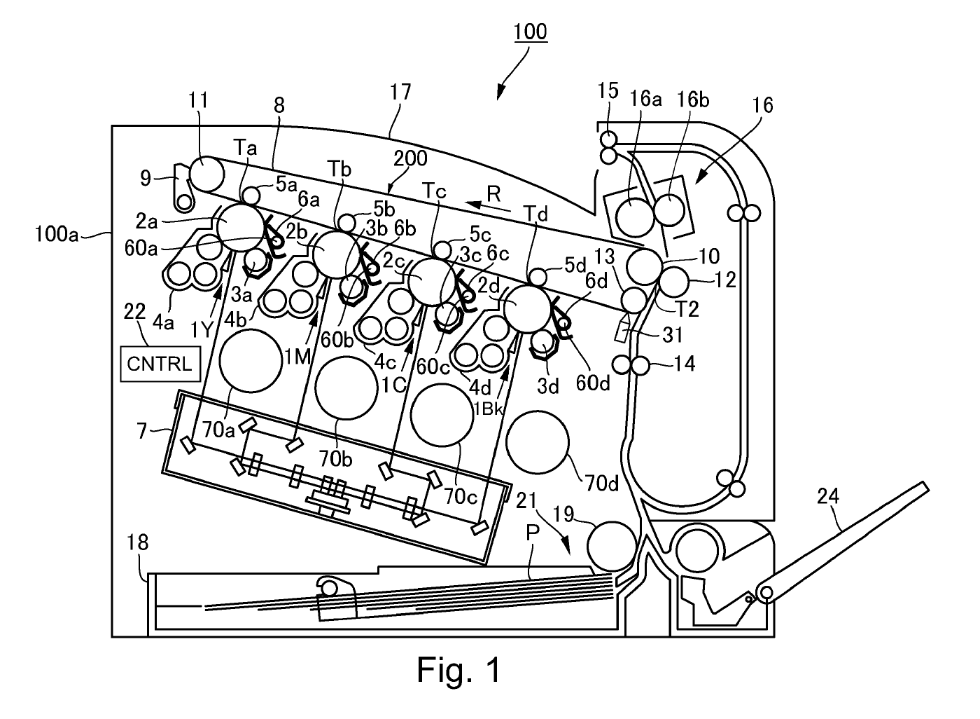

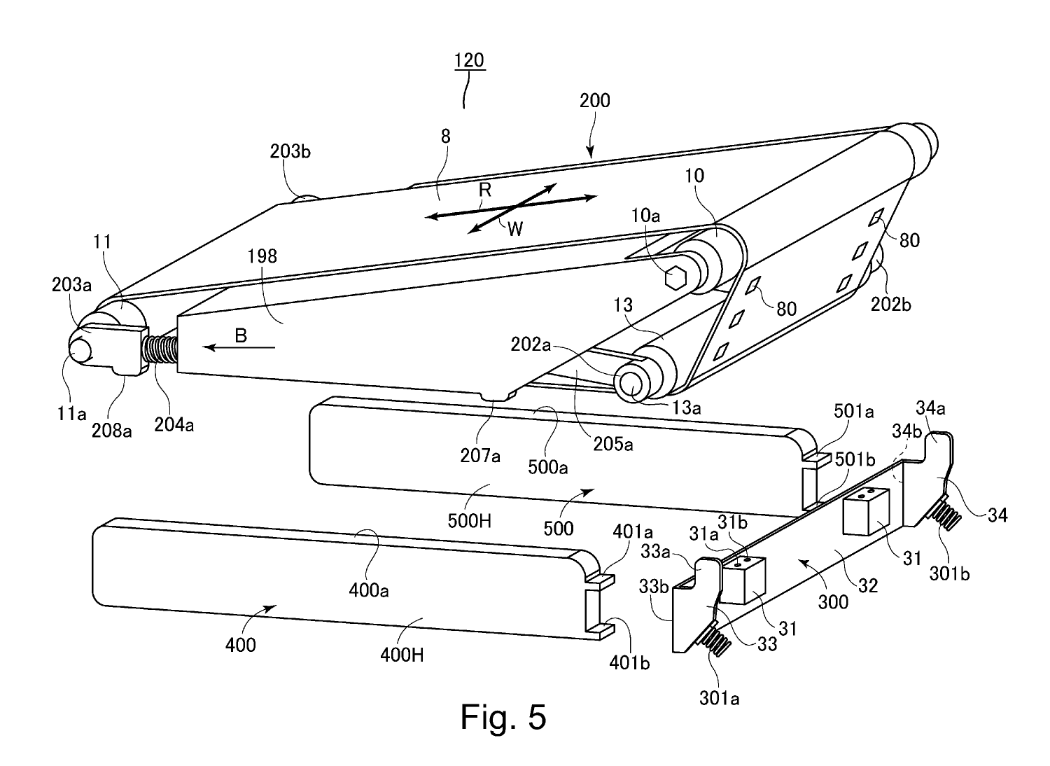

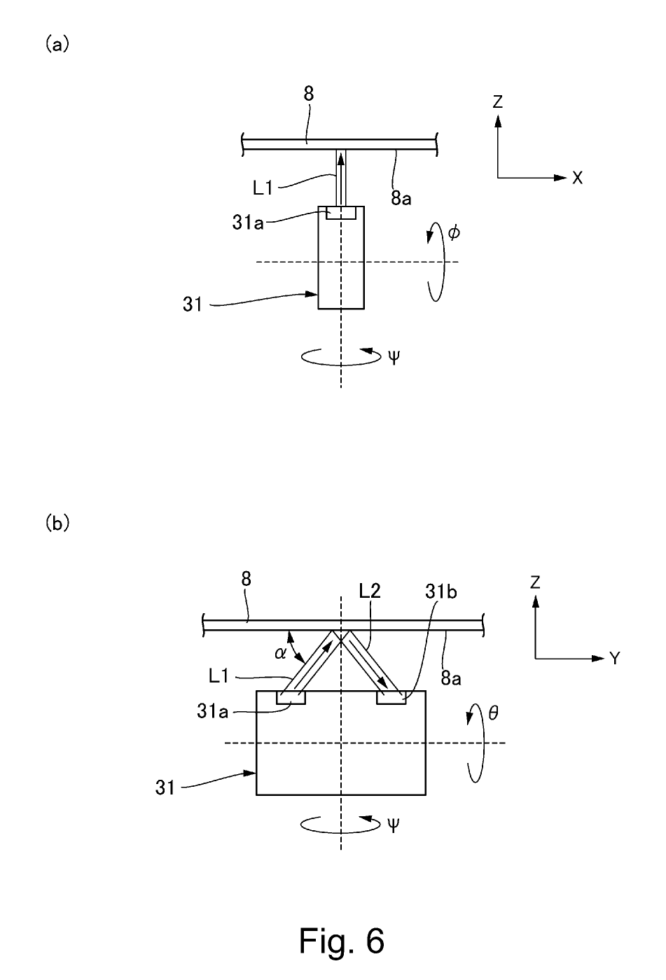

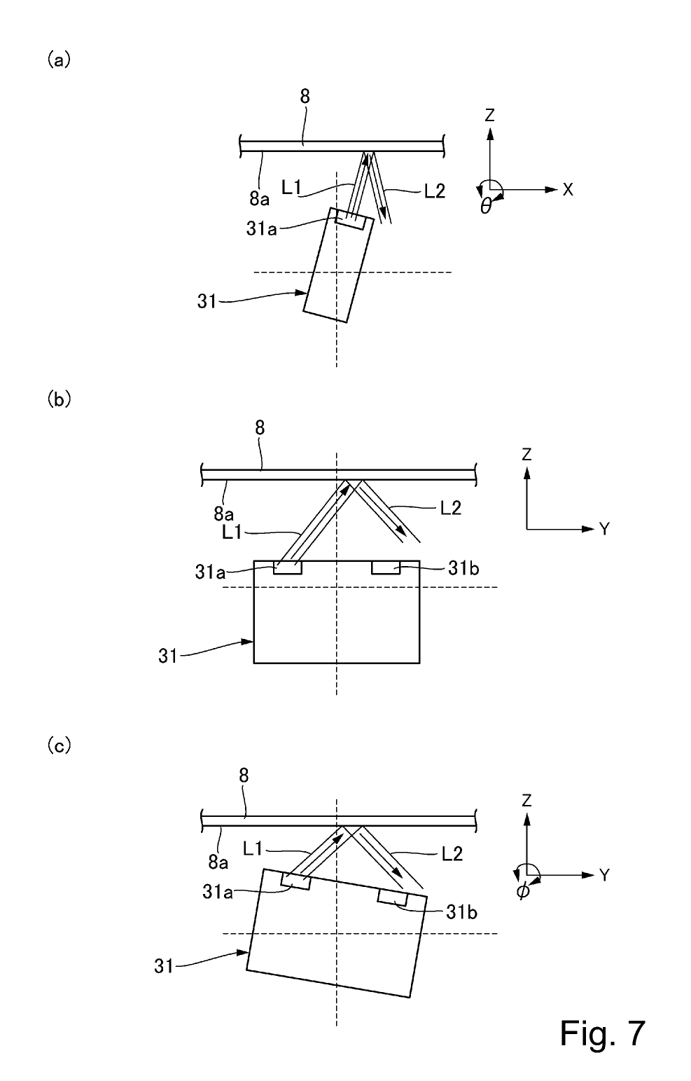

Hereinafter, one of the preferred embodiments of the present invention in the form of an image forming apparatus 100 is described with reference to appended drawings. By the way, if a given component, a section thereof, etc., of the image forming apparatus in a given drawing are the same in referential code as a given component, a section thereof, etc., of the image forming apparatus in another drawing, the former are the same as, or similar to, the latter. FIG. 1 is a schematic sectional view of the image forming apparatus 100 of the so-called intermediary transfer type, and also, of the so-called tandem type, for example, a digital full-color printer. It shows the general structure of the apparatus 100. FIG. 5 is a partially exploded perspective view of the positioning device 120 of the image forming apparatus 100.

### (Image Forming Apparatus 100)

The image forming apparatus 100 has a main assembly 100a. There is an intermediary transfer belt unit 200 as a belt unit, in the top portion of the apparatus main assembly 100a. Further, there are disposed four image forming sections 1Y, 1M, 1C and 1Bk, in the apparatus main assembly 100a. More specifically, the four image forming sections 1Y, 1M, 1C and 1Bk are aligned in tandem in the listed order, in the upstream-to-downstream direction in terms of the circular movement (counterclockwise direction in FIG. 1) of the intermediary transfer belt 8 as an endless belt, along the intermediary transfer belt 8, under the intermediary transfer belt unit 200. Moreover, there is disposed a controlling section 22, as a controlling means, which is equipped with a ROM, a RAM, and a CPU 20 for controlling various sections of the image forming apparatus 100, in the apparatus main assembly 100a.

The image forming apparatus 100 is structured so that its image forming sections 1Y, 1M, 1C and 1Bk which are image formation units for forming an image on the belt unit, form yellow, magenta, cyan and black monochromatic toner images, respectively. The image forming sections 1Y, 1M, 1C and 1Bk are provided with electrophotographic photosensitive components metallic core 2a, 2b, 2c and 2d (which will be referred to simply as “photosensitive drum”). The image forming apparatus 100 is structured so that these photosensitive drums 2a, 2b, 2c and 2d are rotationally driven in the clockwise direction of FIG. 1.

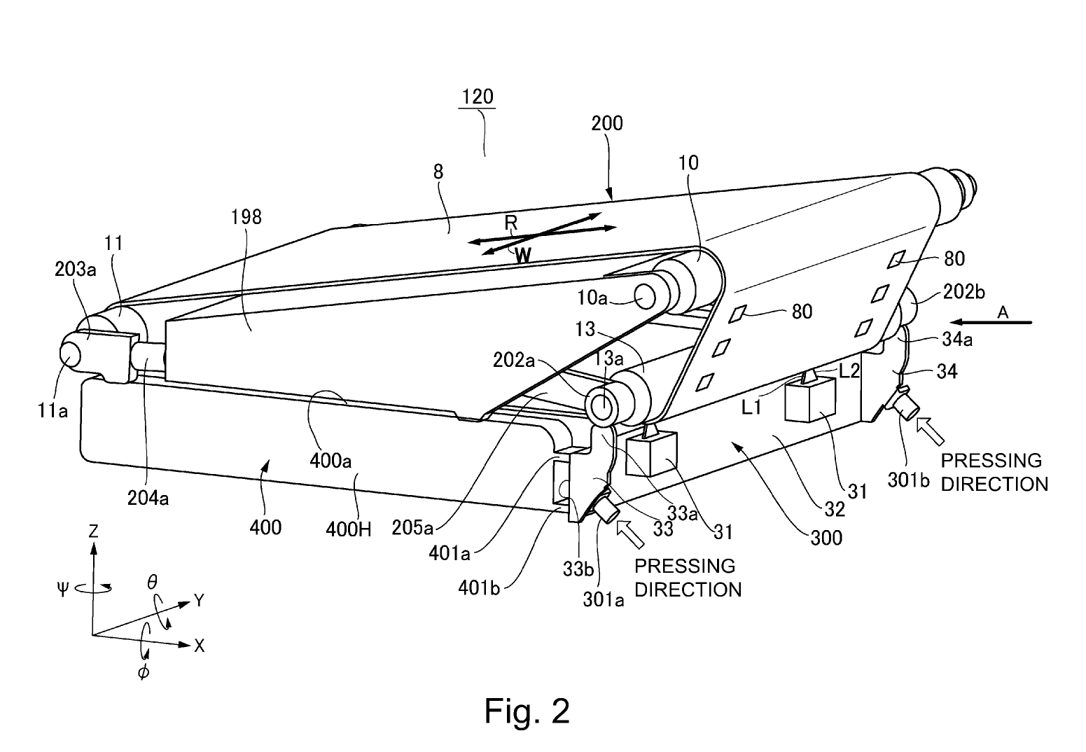

The intermediary transfer belt unit 200 (belt unit) is provided with a driver roller 10, an idler roller 13, and a tension roller 11, which are positioned in a preset relationship, and the intermediary transfer belt 8 which is an endless belt. The intermediary transfer belt 8 is suspended and kept tensioned by the three rollers 10, 13 and 11. That is, the intermediary transfer belt unit 200 has driver roller 10, tension roller 11, and idler roller 13, as belt-suspending-tensioning rollers, which support the intermediary transfer belt 8 so that the intermediary transfer belt 8 can be circularly moved in its circumferential direction (indicated by arrow mark R in FIG. 1 and FIG. 2).

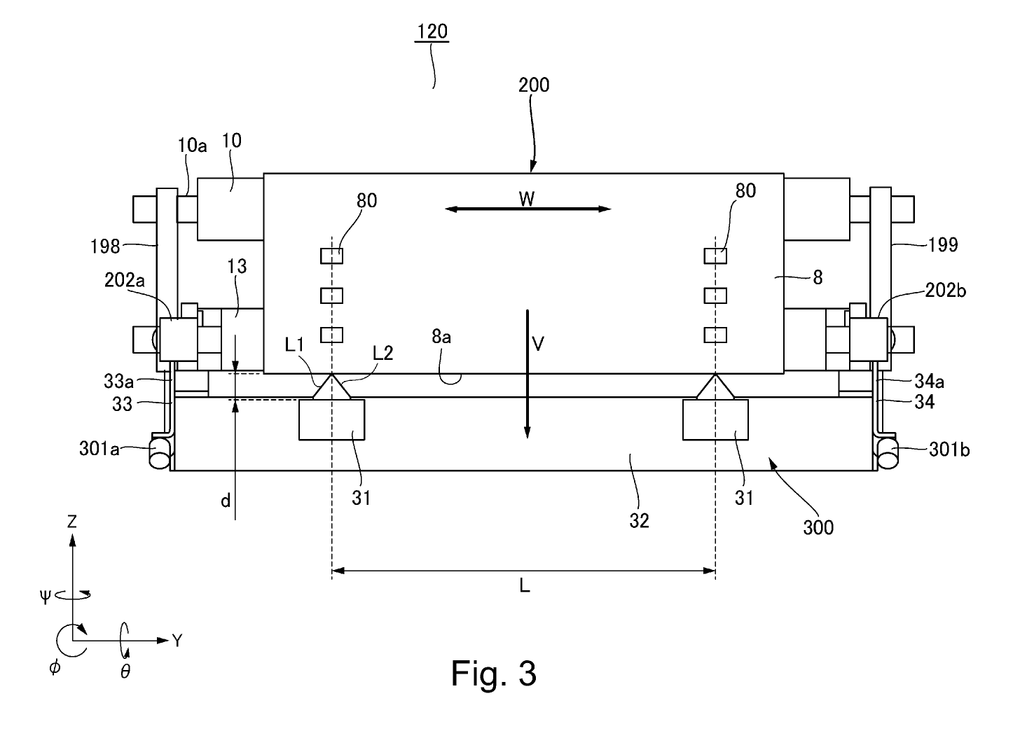

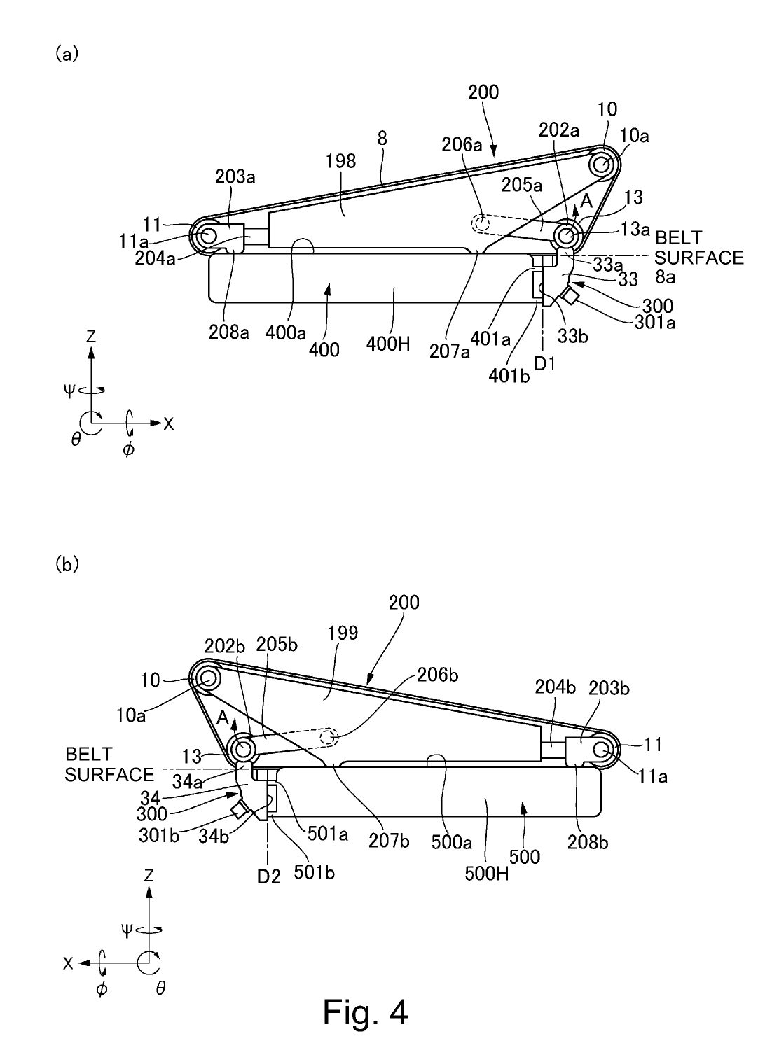

Referring to FIG. 5, in the intermediary transfer belt unit 200, the axle 10a of the driver roller 10 is rotatably supported by one of the lengthwise ends of one of a pair of belt unit frames 198 and 199 (FIG. 3), and the corresponding end of the other belt frame. Further, the axle 11a of the tension roller 11 is rotatably supported at its lengthwise ends, by a pair of tension roller bearings 203a and 203b attached to the opposite end of the belt unit frames 198 and 199 from the driver roller 10, respectively. The intermediary transfer belt 8 is suspended by the combination of the driver roller 10, tension roller 11, and idler roller 13 in such a manner that the inward surface of the intermediary transfer belt 8 remains in contact with the peripheral surface of each of the three rollers 10, 11 and 13. Further, the tension roller 11 is kept under the pressure generated by a pair of tension roller springs 204a and 204b in the direction indicated by an arrow mark B, providing thereby the intermediary transfer belt 8 with tension.

Referring to FIG. 1, the intermediary transfer belt 10 is under the pressure applied thereto by primary transfer rollers 5a, 5b, 5c and 5d, as primary transferring means, from the inward side of the intermediary transfer belt 8 with reference to the loop (belt loop) which the intermediary transfer belt 8 forms. Thus, the outward surface of the intermediary transfer belt 8 remains in contact with the photosensitive drums 2a, 2b, 2c and 2d, in the image forming sections 1Y-1Bk. The intermediary transfer belt 8 remains tensioned leftward (in FIG. 1) by the tension roller 11. The intermediary transfer belt 8 is suspended by the combination of the tension roller 11, driver roller 10, and idler roller 13 in such a manner that the intermediary transfer belt 8 bridges between the adjacent two rollers in terms of the moving direction of the intermediary transfer belt 8, and can be rotationally driven in its circumferential direction (indicated by arrow mark R) by the rotation of the driver roller 10.

The primary transfer rollers 5a, 5b, 5c and 5d are on the inward side of the loop which the intermediary transfer belt 8 forms, and oppose the photosensitive drums 2a, 2b, 2c and 2d, forming thereby primary transfer nips Ta, Tb, Tc and Td, respectively, as primary transferring sections, between the photosensitive drums 2a, 2b, 2c and 2d, and the intermediary transfer belt 8. To each of the primary transfer rollers 5a-5d, positive DC voltage is applied as transfer bias from an unshown bias applying means. Thus, a negatively charged toner image borne on each of the photosensitive drums 2a-2d is transferred (primary transfer) onto the intermediary transfer belt 8 which is being conveyed through the primary transfer nips Ta-Td.

As the driver roller 10, which doubles as a roller which opposes a secondary transfer roller, is rotated in the counterclockwise direction, the intermediary transfer belt 8 is rotated in the same direction by the rotation of the driver roller 10. The rotational speed of the intermediary transfer belt 8 is set to be roughly the same as the rotational speed (process speed) of each of the photosensitive drums 2a-2d.

There is disposed in the adjacencies of the peripheral surface of the photosensitive drum 2a (2b, 2c and 2d), a charge roller 3a (3b, 3c and 3d) as a charging means, and a developing device 4a (4b, 4c and 4d) as developing means, in the listed order in terms of the rotational direction of the photosensitive drum 2. There is also disposed in the adjacencies of the peripheral surface of the photosensitive drum 2a (2b, 2c and 2d), a primary transfer roller 5a (5b, 5c and 5d), and a cleaning device 6a (6b, 6c and 6d), in the listed order in terms of the rotational direction of the photosensitive drum 2a (2b, 2c and 2d). Further, there is disposed on the underside of the combination of the image forming sections 1Y-1Bk, an exposing device 7 as a means for forming a latent image in each of the image forming sections 1Y-1Bk.

The charge roller 3a (3b, 3c and 3d) is rotated by the rotation of the photosensitive drum 2a (2b, 2c and 2d). As an oscillatory voltage, which is a combination of negative DC voltage, and AC voltage, is applied to the charge roller 3a (3b, 3c and 3d) while the photosensitive drum 2a (2b, 2c and 2d) is rotated, the charge roller 3a (3b, 3c and 3d) uniformly charges the photosensitive drum 2a (2b, 2c and 2d) to negative polarity. The exposing device 7 writes an electrostatic image on the peripheral surface of each of photosensitive drums 2a-2d, by outputting a beam of laser light while modulating the beam according to the image data obtained by separating the original (image to be formed) into monochromatic images of primary colors, and reflecting the beam with the use of a rotational mirror in such a manner that the beam scans the peripheral surface of the photosensitive drum. The developing device 4a (4b, 4c and 4d) develops the electrostatic image on the photosensitive drum 2a (2b, 2c and 2d) into a visible image, that is, an image formed of toner (which hereafter will be referred to as “toner image”), by transferring toner onto the photosensitive drum 2a (2b, 2c and 2d).

There is disposed on the underside of the developing devices 4a-4d, toner bottles 70a, 70b, 70c and 70d, respectively. As the toner in the developing devices 4a, 4b, 4c and 4d is consumed by image formation, they are replenished with toner by the toner bottles 7a-7d, respectively.

The cleaning devices 6a (6b, 6c and 6d) removes transfer residual toner, that is, the toner remaining on the peripheral surface of the photosensitive drum 2a on the downstream side of the primary transfer nips Ta (Tb, Tc and Td), by rubbing the peripheral surface of the photosensitive drum 6a (6b, 6c and 6d) with its cleaning blade. The removed toner is conveyed to an unshown toner outlet, by a toner conveyance screw 60a (60b, 60c and 60d), with which the cleaning device 6a (6b, 6c and 6d) is provided. Then, it is discharged through the toner outlet.

There is disposed the secondary transfer roller 12 in contact with the outward surface of the intermediary transfer belt 8, in such a manner that it opposes the driver roller 10. The secondary transfer roller 12 is positioned in such a manner that the intermediary transfer belt 8 is sandwiched between the intermediary transfer belt 8 and driver roller 10. The nip formed between the secondary transfer roller 12 and intermediary transfer belt 8 is the secondary transferring section T2.

The secondary transfer nip T2 is formed by placing the secondary transfer roller 12 in contact with the intermediary transfer belt 8 in such a manner that the secondary transfer roller 12 opposes the driver roller 10 which is one of the rollers by which the intermediary transfer belt 8 is suspended and kept tensioned. The secondary transfer nip T2 transfers the toner images formed on the intermediary transfer belt 8, onto a sheet P of recording medium sent from a recording feeding section 21. To the secondary transfer roller 12 of the secondary transferring section T2, positive DC voltage is applied as the secondary transfer bias, whereby an electric field for transferring toner images is formed between the secondary transfer roller 12 and the grounded driver roller 10. As the secondary transfer bias is applied to the secondary transferring section T2 through the secondary transfer roller 12, the four monochromatic toner images, different in color, on the intermediary transfer belt 8 are transferred (secondary transfer) onto the sheet P of recording medium delivered to the secondary transferring section T2 by the pair of registration rollers 14.

Further, there is disposed a belt cleaning device 9, as a cleaning device of an intermediary transfer component, in contact with the portion of the outward surface of the intermediary transfer belt 8, which corresponds in position to the tension roller 11. The belt cleaning device 9 removes the transfer residual toner, that is, the toner remaining on the surface of the intermediary transfer belt 8 on the downstream side of the secondary transferring section T2 in terms of the moving direction of the intermediary transfer belt 8, by rubbing the surface of the intermediary transfer belt 8 with its cleaning blade (unshown).

On the downstream side of the secondary transferring section T2 in terms of the recording medium conveyance direction, a fixing device 16 having a fixation roller 16a and a pressure roller 16b is disposed. After the transfer of the toner images onto the sheet P of recording medium, the sheet P is conveyed to the fixation nip, which is between the fixation roller 16a and pressure roller 16b. In the fixation nip, heat and pressure are applied to the sheet P and the toner images thereon by the fixation roller 16a and pressure roller 16b. Thus, the toner images on the sheet P become fixed to the sheet P. Further, on the downstream side of the fixing device 16, a pair of discharge rollers 15 and a delivery tray 17 are disposed. By the way, a referential code 24 stands for a manual feed tray.

There is disposed in the bottom portion of the apparatus main assembly 100a, a recording medium feeding-conveying section 21 having a sheet feeder cassette 18, in which sheets P of recording medium which are to be used for image formation are stored in layers. In the recording medium feeding-conveying section 21, the sheets P of recording medium in the cassette 18 are conveyed one by one toward the pair of registration rollers 14 by way of a separation roller 19. Then, each sheet P of recording medium is delivered to the secondary transferring section T2 with preset timing, by way of the pair of registration rollers 14. The separation roller 19 separates one by one the sheets P as it pulls out the sheets P from the sheet feeder cassette 18, and sends each sheet P toward the pair of registration rollers 14. The pair of registration rollers 14 catch each sheet P while remaining stationary. Then, they keep the sheet P on standby. Then, they send each sheet P to the secondary transferring section T2 with the same timing as the timing with which the toner images on the intermediary transfer belt 8 arrives at the secondary transferring section T2.

In the image forming apparatus 100 structured as described above, the toner images formed on the photosensitive drums 2a-2d are sequentially transferred (primary transfer) onto the intermediary transfer belt 8 while the belt 8 is circularly moved in the counterclockwise direction. The transfer of the toner images from the photosensitive drums 2a-2d onto the intermediary transfer belt 8 is done by the application of the positive bias to the primary transfer rollers 5a-5d, respectively. The four toner images, different in color, layered on the intermediary transfer belt 8, as described above, are moved to the secondary transferring section T2.

Meanwhile, the toner remaining on the peripheral surface of the photosensitive drum 2a (2b, 2c and 2d) after the transfer of the toner image therefrom, is removed by the cleaning device 6a (6b, 6c and 6d). As for the toner remaining on the intermediary transfer belt 8 after the secondary transfer, it is removed by a belt cleaning device 9. The removed toner is recovered into a container for recovered toner, through a recovery toner conveyance passage (unshown).

Next, referring to FIGS. 6 and 7, the definition of sensor attitude, and the changes in sensor attitude, are described. By the way, parts (a) and (b) of FIG. 6 are schematic drawings for describing the definition of the sensor attitude. part (a) of FIG. 7 is a schematic drawing of the sensor 31 of the reflection type, after the angular deviation of the sensor 31 in the direction indicated by a two-headed arrow mark θ, and part (b) of FIG. 7 is a schematic drawing of the sensor 31 of the reflection type, after the linear deviation of the sensor 31 in the direction indicated by an arrow mark Z. Part (c) of FIG. 7 is a schematic drawing of the sensor 31 of the reflection type, after the linear deviation of the sensor 31 in the direction indicated by a two-headed arrow mark φ.

To begin with, referring to parts (a) and (b) of FIG. 6, the sensor 31 of the reflection type, which is an optical sensor, is properly positioned relative to the surface 8a of the intermediary transfer belt 8, in terms of each of the directions X, Y and Z. That is, the sensor 31 of the reflection type, which detects the light projected upon the intermediary transfer belt 8, is properly held with respect to the direction indicated by the arrow mark φ (angle about axis X), direction indicated by the arrow mark θ (angle about axis Y), and direction Z. Thus, a beam L of light projected from the light emitting section 31a hits the surface 8a of the intermediary transfer belt 8 at a proper angle α, is reflected by the surface 8a at a proper angle, and is accurately caught by the light receiving section.

In comparison, referring to part (a) of FIG. 7, if the sensor 31 of the reflection type (which hereafter will be referred to as reflection type sensor) angularly deviates in the direction θ, that is, the direction about axis X, the beam L1 projected from the light emitting section 31a is reflected by the surface 8a in a direction which is slightly different from the direction of the light receiving section 31b, failing therefore to be properly received by the light receiving section 31b. Further, referring to part (b) of FIG. 7, if the reflection type sensor 31 deviates in the direction Z (moves away from surface 8a), the beam L1 of light is reflected by the surface 8a at a position which is closer to the light receiving section 31b than the normal position, failing therefore to be properly received by the light receiving section 31b. Further, referring to part (c) of FIG. 7, if the reflection type sensor 31 tilts in the direction φ, that is, the direction about the axis X, the beam L1 of light is reflected by the surface 8 at a position which is closer to the light receiving section 31b than the normal position, failing therefore to be properly received.

### (Details of Positioning Device 120)

Next, referring to FIGS. 2-5, the positioning device 120 in this embodiment, which makes it possible to prevent the reflection type sensor 31 from being improperly positioned as shown in parts (a)-(c) of FIG. 7, is described. By the way, FIG. 2 is a perspective view of the entirety of the positioning device 120, and FIG. 3 is a side view of the positioning device 120 as seen from the direction indicated by an arrow mark A in FIG. 2. Part (a) of FIG. 4 is a front view of the positioning device 120, and part (b) of FIG. 4 is a rear view of the positioning device 120.

The image forming apparatus 100 forms a test patch 80 which has a preset pattern, on the intermediary transfer belt 8, with the use of the image forming sections 1Y, 1M, 1C and 1Bk which are in the form of a drum cartridge, with preset timing. The test patch having the preset pattern is formed on the intermediary transfer belt 8 through the same process as the normal process for forming an image, in order to detect the density deviation, positional (color) deviation, and toner image formation timing.

As the test patch 80 is detected by the reflection type sensor 31 as a sensor, the control section 22 carries out the control for optimizing the image forming apparatus 100 in the density of the toner image formed by each of the image forming sections 1Y, 1M, 1C and 1Bk, and the timing with which the toner image is formed by each of the image forming sections 1Y, 1M, 1C and 1Bk, based on the information obtained by the detection. The reflection type sensor 31 has the light emitting section 31a (FIG. 5) which emits the beam L1 of light, and the light receiving section 31b (FIG. 5) which catches the beam L2 of light, that is, the beam L1 reflected by the intermediary transfer belt 8.

Next, a density detection test patch formed as the test patch 80 in this embodiment, and how the density is detected by the reflection type sensor 31 in this embodiment, are described.

Referring to FIG. 3, the positioning device 120 is provided with a pair of reflection type sensors 31, which are positioned so that they align in the widthwise direction of the intermediary transfer belt (front-rear direction of apparatus), with the provision of a preset amount of distance between the pair of positioning device 120, and also, so that their position coincides with the position of the test patch 80. The reflection type sensors 31 and 31 are disposed on the underside of the intermediary transfer belt 8, being positioned directly below the idler roller 13, with the provision of a preset distance d between the reflection type sensors 31 and surface 8a of the intermediary transfer belt 8.

Next, referring to FIGS. 2, 3 and 5, the pair of reflection type sensors 31 are parts of a sensor unit 300, and are fixed to a sensor unit frame 32 as a sensor supporting component, being aligned in the widthwise direction of the intermediary transfer belt 8 as described above. The two reflection type sensors 31 are the same in structure. The sensor unit frame 32 has: surfaces 33b and 34b as first positioning sections, and protrusive sections 33a and 34a as second positioning section.

That is, the sensor unit frame 32 is positioned so that its lengthwise direction becomes parallel to the widthwise direction (indicated by arrow mark W) of the intermediary transfer belt 8. The lengthwise ends of the sensor unit frame 32 are provided with a pair of bent sections 33 and 34, one for one, which are perpendicular to the main section of the sensor unit frame 32, and have protrusions 33a and 34a, and surfaces 33b and 34b, respectively. The two reflection type sensors 31 are fixed to the sensor unit frame 32, close to the lengthwise ends of the sensor unit frame 32, one for one. Therefore, the test patches 80 can be positioned relative to the surface 8a of the intermediary transfer belt 8 with a high level of accuracy. The surface 33b as the first positioning section remains in contact with the sensor positioning protrusions 401a and 401b as the second positioning section, whereas the surface 34b as the second positioning section remains in contact with the sensor positioning protrusions 501a and 501b as the second positioning section. The sensor positioning protrusions 401a, 401b, 501a and 501b position the sensor unit frame 32 by remaining in contact with the sensor unit frame 32.

The sensor unit 300 is also provided with a pair of pressure application springs 301a and 301b such as compression springs as pressure applying means for pressing the sensor unit frame 32. It is structured so that a combination of the protrusive section 33a, and a combination of surfaces 33b and surface 34b remain pressured diagonally upward in the left-to-right direction from the bottom-right portion of FIG. 2. The sensor unit 300 is supported by an unshown supporting means in such a manner that it is allowed to move in the direction which is parallel to the direction in which pressure is applied by the pressure application springs 301a and 301b. However, the movement of the sensor unit frame 32 is regulated by the abovementioned supporting means so that even when the idler roller 13 retreats upward as will be described later, the sensor unit frame 32 which is under the pressure generated by the pressure application springs 301a and 301b does not move upward beyond a preset level.

That is, the pressure application springs 301a and 301b press the sensor unit frame 32 so that the surface 33b remains in contact with the protrusive sections 401a and 401b; the surface 34b, in contact with the protrusive sections 501a and 501b; and protrusive sections 33a and 34a remain in contact with the bearings 202a and 202b. The sensor unit frame 32 is pressed by the opposite lengthwise end of each of the pressure application springs 301a and 301b, from the lengthwise end by which the pressure application springs 301 are supported by the apparatus main assembly 100a.

The bearings 202a and 202b which are parts of the intermediary transfer belt unit 200 make up the supporting sections. These supporting sections support the axle 13a of the idler roller 13 which is one of the belt-suspending-tensioning rollers and is in the adjacencies of the sensor positioning protrusions 401a, 401b, 501a and 501b.

The sensor positioning protrusions 401a and 401b are parts of the positioning component 400, and protrude from the main section 400H of the positioning component 400. The sensor positioning protrusions 501a and 501b are parts of the positioning component 500, and protrude from the main section 500H of the positioning component 500. Further, the positioning protrusions 401a and 501a are the first positioning protrusions, and the positioning protrusions 401b and 501b are the second positioning protrusions. Further, an interface D1 (part (a) of FIG. 4), which will be described later, coincides with the end surface of each of the sensor positioning protrusions 401a and 401b, and an interface D2 (part (b) of FIG. 4), coincides with the end surface of each of the sensor positioning protrusions 501a and 501b.

The positioning components 400 and 500 are fixed to preset positions in the apparatus main assembly 100a (FIG. 1). Referring to FIG. 5, the intermediary transfer belt unit 200 is positioned by being placed in contact with the positioning surfaces 400a and 500a, as the first positioning sections, which are the top surfaces of the positioning components 400 and 500, respectively. That is, these positioning surfaces 400a and 500a position the intermediary transfer belt unit 200 as the intermediary transfer belt unit 200 is placed in contact with them, respectively.

The positioning components 400 and 500 are disposed on the front and rear sides, respectively, of the intermediary transfer belt unit 200 in terms of the widthwise direction (indicated by arrow mark W) which is intersectional (perpendicular) to the circumferential direction (indicated by arrow mark R) of the intermediary transfer belt 8. Thus, the intermediary transfer belt unit 200 can be mounted on the positioning surfaces 400a and 500a while remaining in balance in terms of the widthwise direction (W).

Referring to parts (a) and (b) of FIG. 4, the intermediary transfer belt unit 200 has protrusive sections 207a, 208a, 207b and 208b as positioning sections, which are placed in contact with the above-described positioning surfaces 400a and 500a.

That is, in order to control the belt unit 200 in attitude in terms of the direction 8, the positioning component 400 has the positioning surface 400a, with which the protrusive section 207a of the belt unit frame 198 and the protrusive section 208a of the tension roller bearing 203a, are placed in contact. In order to control the belt unit 200 in attitude in terms of the direction θ, the positioning component 500 has the positioning surface 500a, with which the protrusive positioning section 207b of the belt unit frame 199, and the protrusive positioning section 208b of the tension roller bearing 203b, are placed in contact.

Thus, the protrusive positioning sections 207a and 207b of the belt unit frames 198 and 199, respectively, and the protrusive positioning sections 208a and 208b of the tension roller bearings 208a and 203b, respectively, contact the positioning surfaces 400a and 500a, respectively. Therefore, the belt unit frame 198 and belt unit frame 199 are controlled in position in terms of the direction Z, and also, in angle in terms of the direction θ. Therefore, the surface 8a of the intermediary transfer belt 8 which is suspended and kept tensioned by the driver roller 10, tension roller 11, and idler roller 13 which are in connection to the frames 198 and 199, is controlled in angle in terms of the direction θ.

Further, the protrusive sections 33a and 34a controls the sensor unit 300 in position in terms of the direction which is roughly parallel to the interfaces D1 and D2. Each of the sensor positioning protrusions 401a and 401b has a surface which that coincides with the above-described interface D1, and contacts the sensor unit frame 32 which is under the pressure generated by the pressure application springs 301a and 301b. Further, each of the sensor positioning protrusions 501a and 501b has a surface which coincides with the above-described interface D2, and contacts the sensor unit frame 32 which is under the pressure generated by the pressure application springs 301a and 301b.

The intermediary transfer belt unit 200 is structured so that the interfaces D1 and D2 become roughly perpendicular to the surface 8a of the intermediary transfer belt 8, which the reflection type sensors 31 face. That is, referring to part (a) of FIG. 4, the intermediary transfer belt unit 200 is structured so that the interface D1, which coincides with the end surface of sensor positioning protrusion 401a, and the end surface of the sensor positioning protrusion 401b, becomes roughly perpendicular to the surface 8a of the intermediary transfer belt 8, as seen from the front-to-rear direction (direction Y) in part (a) of FIG. 4. Referring to part (b) of FIG. 4, the intermediary transfer belt unit 200 is structured so that the interface D2 which coincides with the end surface of the sensor positioning protrusion 501a and 501b, becomes roughly perpendicularly intersects with the surface 8a. Therefore, the intermediary transfer belt unit 200 in this embodiment is more stable, and better in the level of accuracy with which the test patch 80 is detected than any of conventional intermediary transfer belt unit (200).

With the provision of the above-described structural arrangement, the protrusive sections 33a and 34a of the sensor unit frame 32 remain in contact with the bearings 202a and 202b, respectively, and the surfaces 33b and 34b of the sensor unit frame 32 remain in contact with the sensor positioning protrusions 401a and 401b and the sensor positioning protrusion 501a and 501b, respectively. Thus, the sensor unit frame 32 is accurately positioned relative to the surface 8a of the intermediary transfer belt 8, with reference to the positioning components 400 and 500.

As described above, the positioning components 400 and 500 have the positioning surfaces 400a and 500a as the first positioning sections, and sensor positioning protrusions 401a, 401b, 501a and 501b. Therefore, the positioning components 400 and 500 function as shared positioning sections for both the intermediary transfer belt unit 200 and sensor unit frame 32, while remaining fixed to the apparatus main assembly 100a. Therefore, the intermediary transfer belt unit 200 in this embodiment is substantially higher in the level of accuracy with which the reflection type sensors 31 are positioned relative to the intermediary transfer belt 8 than any conventional intermediary transfer belt unit (200).

The positioning surfaces 400a and 500a as the first positioning sections control the position of the intermediary transfer belt unit 200 in terms of vertical direction (indicated by arrow mark V in FIG. 3), and the interfaces D1 and D2 are formed to be roughly parallel to the vertical direction. Therefore, the positional relationship between the surface 8a of the intermediary transfer belt 8 and the reflection type sensor 31 is maintained at a high level of accuracy.

In this embodiment, the idler roller 13 is attached to the pivotal bearings 205a and 205b attached to the belt unit frames 198 and 199. The intermediary transfer belt unit 200 is structured so that the belt unit frame 198 and 199 can be slid out of the apparatus main assembly 100a, along with the intermediary transfer belt unit 200, in the direction indicated by the arrow mark X in part (a) of FIG. 4, when the intermediary transfer belt unit 200 reaches the end of its life span, or it needs to be replaced due to the occurrence of unexpected malfunction or the like. In order to allow the intermediary transfer belt unit 200 to be slid out of the apparatus main assembly 100a, the sensor unit 300 and intermediary transfer belt unit 200 need to be separated from each other. Therefore, the idler roller 13 is supported in such a manner that it can be pivotally moved about the pivots 206a and 206b of the belt unit frame 198 and 199, respectively, in the direction indicated by the arrow mark A in parts (a) and (b) of FIG. 4.

As described above, the angular deviation of the reflection type sensor 31 relative to the surface 8a of the intermediary transfer belt 8 in terms of the direction θ is as follows. That is, it is a combination of the angular deviation of the protrusive positioning sections 207a, 208a, 207b and 208b which control the surface 8a and intermediary transfer belt unit 200 in attitude, and the accuracy of the positioning components 400 and 500. Therefore, it is minimized that the angle (attitude) of the reflection type sensor 31 relative to the surface 8a is affected by the inaccuracy of the apparatus main assembly 100a and the components thereof in terms of size and shape.

Further, because the sensor unit frame 32 is directly in contact with the bearings 202a and 202b for the idler roller 13, the distance between the intermediary transfer belt 8 and reflection type sensor 31 is unlikely to be affected by the inaccuracy in the shape and size of the components other than the pivotal bearings 205a and 205b. Therefore, the inaccuracy in the distance d (FIG. 3) between the reflection type sensor 31 and surface 8a of the intermediary transfer belt 8 remains very small. Therefore, both the angle of the reflection type sensor 31 relative to the surface 8a of the intermediary transfer belt 8 in terms of the direction θ, and the distance between the reflection type sensor 31 and surface 8a in terms of the direction Z, are unlikely to substantially deviate, regardless of the tolerance in the components of the apparatus main assembly 100a.

Therefore, in the case of the image forming apparatus 100, it is ensured that the test patches 80 which are formed on the intermediary transfer belt 8 by the image forming sections 1Y, 1M, 1C and 1Bk are accurately detected by the reflection type sensors 31 which remain highly precisely positioned as described above. The information obtained by the detection of the test patches 80 is sent to the control section 22 (FIG. 1). The control section 22 compares the information with referential values, and sends control signals which correspond to the necessary amount of correction, to the devices, components and sections thereof which are to be controlled, to control them. Thus, the image forming sections 1Y, 1M, 1C and 1Bk are optimized in the density of the toner images they form.

By the way, in this embodiment, the test patches 80 for detecting image density are formed on the intermediary transfer belt 8, and are detected by the reflection type sensors 31. However, this embodiment is not intended to limit the present invention in scope. That is, the image forming apparatus 100 may be structured so that test patches for positional deviation (color deviation) are formed on the intermediary transfer belt 8, and are detected by the reflection type sensors 31.

Further, the image forming apparatus 100 may be structured so that both the test patches 80, and the patches for detecting positional deviation (unshown), are formed on the intermediary transfer belt 8, and are detected by reflection type sensors 31 dedicated to the test patches 80, and the reflection type sensors dedicated to the test patches for detecting positional deviation. In other words, this embodiment is not intended to limit the present invention in terms of the number, usage, position, etc., of the reflection type sensors to be attached to the sensor unit frame 32, and also, in terms of the pattern in which the test patches 80, and the test patches for detecting positional deviation (unshown), are formed.

Moreover, in this embodiment, the image forming apparatus 100 is provided with four image forming sections 1Y, 1M, 1C and 1Bk. However, this embodiment is not intended to limit the present invention in scope. That is, the present invention is also applicable to an image forming apparatus having one image formation unit comprising one photosensitive drum, and four developing devices disposed in the adjacencies of the peripheral surface of the photosensitive drum.

Furthermore, in this embodiment, the test patches 81 are formed on the intermediary transfer belt 8. However, the present invention is also applicable to an image forming apparatus which forms the test patches 80 on its sheet conveyance belt, with the same effects as those described above.

According to this embodiment, the angle of the sensor unit 300 in terms of the direction θ is controlled by the positioning components 400 and 500 which controls the attitude of the intermediary transfer belt unit 200. Therefore, the angular deviation of the sensor unit 300 relative to the intermediary transfer belt 8, in terms of the direction θ, which is attributable to the inaccuracy of the components of the intermediary transfer belt unit 200, can be extremely effectively minimized.

Further, the bearings 202a and 202b are directly placed in contact with the sensor unit frame 32 in terms of the direction Z. Therefore, the bearings 202a and 202b are positioned without being affected by the accuracy of the positioning components 400 and 500, and the other components of the intermediary transfer belt unit 200 than the sensor unit frame 32. Therefore, the image forming apparatus 100 in this embodiment is superior to any conventional image forming apparatus in terms of the level of accuracy with which the combination of the apparatus main assembly 100a and intermediary transfer belt unit 200 is corrected in color deviation. That is, this embodiment (present invention) can provide an image forming apparatus (100) which affords more latitude for the color deviation and density deviation which are attributable to the environmental changes, and repetition of image formation (cumulative length of usage of image forming sections).

As described above, in this embodiment, positioning of the intermediary transfer belt unit 200 and sensor unit frame 32 (sensor unit 300) relative to each other is done by pressing sensor unit 300 diagonally upward from the bottom right end of the sensor unit 300 through the positioning components 400 and 500. Further, referring to part (a) of FIG. 4, the angle of the reflection type sensor 31 in terms of the direction 6 is properly controlled by placing sensor unit frame 32 in contact with the sensor positioning protrusions 401a 401b, 501a and 501b. Moreover, the sensor unit frame 32 is also placed in contact with the bearings 202a and 202b for the idler roller 13. Therefore, the distance between the reflection type sensor 31 and intermediary transfer belt 8 in terms of the direction Z is properly controlled by the protrusive sections 33a and 33b.

Therefore, the angle of the beams L1 and L2 of light emitted by the reflection type sensor 31, relative to the surface 8a of an endless belt such as the intermediary transfer belt 8, sheet conveyance belt, etc., is precisely controlled. Further, it is ensured that the test patches 80 formed on an endless belt such as the intermediary transfer belt 8 are precisely detected by the reflection type sensors 31.

### INDUSTRIAL APPLICABILITY

According to the present invention, the angle of a sensor relative to an endless belt can be precisely controlled. Therefore, it is possible to provide an image forming apparatus which can precisely detect test patches with its sensor.

1. An image forming apparatus comprising:
a belt unit including an endless belt capable of traveling around a plurality of stretching rollers supporting said endless belt;
an image forming unit configured to form a toner image on said belt;
a sensor unit including a sensor including a light emitting portion and a light receiving portion and configured to detect light from said belt;
a setting portion configured to set an image forming condition of said image forming unit in accordance with an output of said sensor;
a positioning member including, at each of end portions of said belt with respect to a widthwise direction crossing with a moving direction of said belt, a first portion-to-be-contacted contacting said belt unit at a plurality of positioning places and a second portion-to-be-contacted contacting said sensor unit at a plurality of positioning places.

2. An apparatus according to claim 1, wherein said positioning member is disposed at each of end portions with respect to the widthwise direction.

3. An apparatus according to claim 1, further comprising a supporting member extending in the widthwise direction to support said sensor, wherein said sensor supporting member is positioned by contacting said positioning member.

4. An apparatus according to claim 1, wherein said belt unit including a stretching roller supporting member for supporting said plurality of stretching rollers, and said stretching roller supporting member is positioned by contacting said positioning member.

5. An apparatus according to claim 1, wherein the light from said light emitting portion is projected onto a flat surface portion of said belt adjacent a first stretching roller of said stretching rollers, and a plane including a line connecting said light emitting portion and said light receiving portion and a position of said belt where the light is projected is perpendicular to the flat surface portion.

6. An apparatus according to claim 1, further comprising an openable and closable door member, wherein said belt unit is detachably mountable relative to the main assembly in a state that said door member is opened.

7. An apparatus according to claim 6, wherein the positioning places of said first portion-to-be-contacted are arranged substantially in a horizontal direction, and said belt unit is mounted and dismounted relative to a main assembly of said apparatus substantially in a horizontal direction.

8. An apparatus according to claim 6, wherein the positioning places of said second portion-to-be-contacted are arranged substantially in a vertical direction, and said sensor unit is disposed in a side of said door member with respect to said positioning member.

9. An apparatus according to claim 6, wherein said sensor unit is movable when said belt unit is mounted and dismounted, and wherein said apparatus further comprises an urging member for urging said sensor unit toward said positioning member in a state that said belt unit is mounted to a main assembly of the apparatus.

10. An apparatus according to claim 6, wherein said urging member urges said sensor unit toward said positioning member and toward a supporting portion supporting said first stretching roller.

11. An apparatus according to claim 6, wherein said plurality of stretching rollers includes a second stretching roller provided adjacent to a downstream side of first stretching roller with respect to the moving direction of said belt, and said second stretching roller is a driving roller configured to apply a driving force to said belt.

12. An apparatus according to claim 11, wherein said second stretching roller has a diameter smaller than a diameter of said first stretching roller.
